(19) United States
(12) Patent Application Publication
(10) Pub. No.: US 2010/0015034 A1
(43) Pub. Date: Jan. 21, 2010

(54) PROCESSES FOR OXIDIZING HYDROGEN BROMIDE TO PRODUCE ELEMENTAL BROMINE

(75) Inventors: Tyson J. Hall, Baton Rouge, LA (US); Bonnie Gary Mckinnie, Magnolia, AR (US)

Correspondence Address: ALBEMARLE CORPORATION;PATENT DEPARTMENT, 451 FLORIDA STREET, BATON ROUGE, LA, 70801, US

(73) Assignee: ALBEMARLE CORPORATION, Baton Rouge, LA (US)

(21) Appl. No.: 12/523,959

(22) PCT Filed: Feb. 13, 2008
(86) PCT No.: PCT/US2008/053802

§ 371 Date: Jul. 21, 2009

Related U.S. Application Data
(60) Provisional application No. 60/905,007, filed on Feb. 28, 2007.

(51) Int. Cl. C01B 7/09

(52) U.S. Cl. 423/502

(57) ABSTRACT

Processes are provided for catalytic oxidation of bromide to bromine by use of oxygen at temperatures of at least about 315° C. in the presence of a cerium-containing compound, such as a cerium bromide catalyst, wherein the produced stream comprising Br₂ and H₂O is directly cooled with water. The bromide and the oxygen may be heated directly with steam.

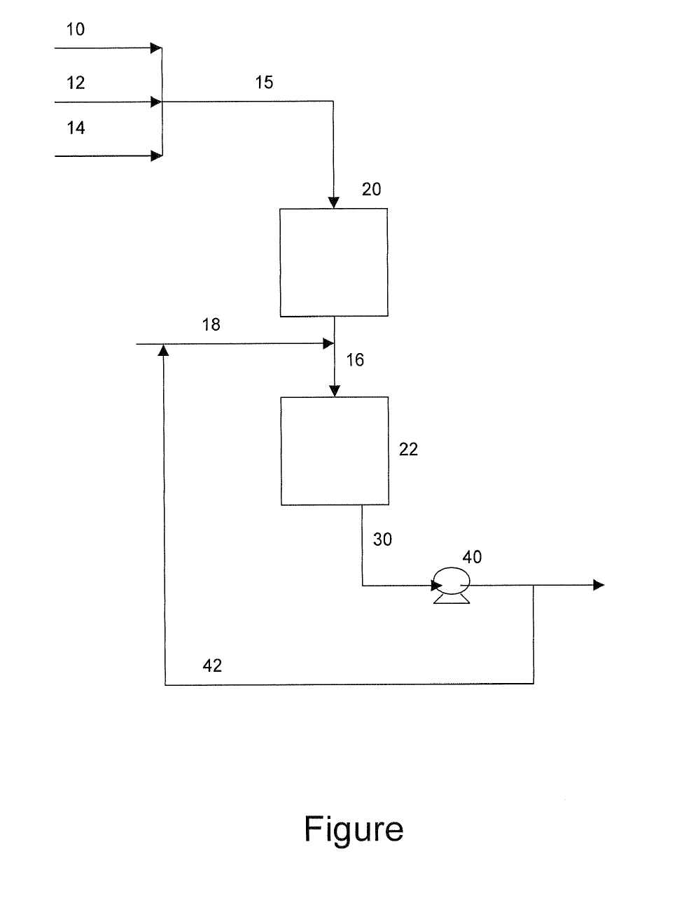

### BACKGROUND

Bromine is useful in a wide range of industries. For example, bromine is used in the manufacture of brominated flame retardants such as tetrabromobisphenol-A, decabromodiphenylethane, decabromodiphenyl oxide, and brominated polystyrenes. Bromine is also used, e.g., in the manufacture of 1,2-dibromoethane, which is used as a petrol additive, in the manufacture of compounds used in photography (e.g. silver bromide, which is the light sensitive material in film), in the manufacture of dyestuffs and drugs, in analytical laboratory in testing for unsaturation in organic compounds, as a disinfectant, and in gold extraction.

In 2005, the EPA issued the Clean Air Mercury Rule to cap and reduce mercury emissions from coal-fired power plants. This rule, combined with the EPA's Clean Air Interstate Rule (CAIR), will require significant reduction in mercury emissions from coal-fired power plants as early as 2010. The Department of Energy has presented information from several studies that indicate mercury emissions during combustion of coal fuels can be lowered by treatment of the coal fuel stocks with low levels of bromine. Such applications could require significant amounts of bromine.

Brines that are produced in several areas of the world contain substantial quantities of bromide salts, such as sodium bromide. Processes for production of bromine from brines and other bromide-containing solutions are well know. For example, bromine can be produced by a bromine steaming out process, such as Kubierschky's distillation method; see, e.g., Kirk-Othmer, Encyclopedia of Chemical Technology, Fourth Edition, volume 4, pages 548 through 553. Other methods for recovering bromine from bromide-containing solutions are described, e.g., in U.S. Pat. No. 3,181,934, U.S. Pat. No. 4,719,096, U.S. Pat. No. 4,978,518, U.S. Pat. No. 4,725,425, U.S. Pat. No. 5,158,683, and U.S. Pat. No. 5,458,781. For example, bromine can be recovered from brines by treatment with chlorine to oxidize the bromide to bromine. Processes for electrolytic conversion of bromide to bromine are also known; but electrolytic conversion is an expensive alternative compared to other processes.

Catalytic oxidation of bromide to bromine by use of oxygen or air mixtures has been reported. For example, U.S. Pat. No. 5,366,949 describes such a process. However, no successful, economic, commercial operation is in place today.

It would be commercially beneficial to have efficient methods for catalytic oxidation of bromide to bromine by use of oxygen or air mixtures.

### THE INVENTION

This invention meets the above-described needs by providing methods for catalytic oxidation of bromide to produce elemental bromine (Br₂) by use of oxygen or air mixtures.

Processes are provided for producing Br₂ comprising: a) combining at least HBr and oxygen in the presence of a cerium-containing compound at at least about 315° C. to produce a product stream comprising Br₂ and H₂O; and b) cooling the product stream directly with a cooling stream comprising water. In such processes HBr may be anhydrous. Also provided are processes for producing Br₂ comprising: a) heating at least HBr and oxygen directly with steam to at least about 315° C.; b) placing at least the heated HBr and oxygen in the presence of a cerium-containing compound to produce a product stream comprising Br₂ and H₂O; and c) cooling the product stream directly with a cooling stream comprising water. Also provided are processes for producing Br₂ comprising: a) heating HBr directly with steam to at least about about 315° C.; b) combining at least oxygen and the heated HBr at at least about 315° C. in the presence of a cerium-containing compound to produce a product stream comprising Br₂ and H₂O; and c) cooling the product stream directly with a cooling stream comprising water. In such processes, the product stream can be cooled to produce a liquid product stream. In such processes the cooled product stream can be further processed to separate the Br₂ from the H₂O.

In processes of this invention, at least HBr and oxygen can be combined in the presence of a cerium-containing compound, e.g., at at least about 315° C. (600° F.) to about 1000° C. (1832° F.), or at at least about 315° C. (600° F.) to about 538° C. (1000° F.). As will be familiar to those skilled in the art, the upper temperature can be limited by the ability of the cerium-containing compound and/or of the processing equipment to withstand the temperature of operation.

The invention will be better understood by reference to the FIGURE, which is a flow diagram representative of processes according to this invention.

The descriptions in this specification are illustrative of the principles of this invention. It is understood that this invention is not limited to any one specific embodiment exemplified herein, whether in the examples or the remainder of this patent application.

Referring to the FIGURE, in one process according to this invention, stream 10 comprising HBr, stream 12 comprising oxygen, and stream 14 comprising steam are combined to form stream 15 having a temperature higher than about 315° C. Stream 15 is input to reactor 20 containing a cerium-containing compound, e.g., a catalyst comprising cerium bromide. Stream 16 comprising Br₂ and H₂O exits reactor 20 and is cooled directly with liquid from stream 18 comprising water in cooler 22. Stream 30 comprising H₂O and Br₂ exits cooler 22, and can be pumped via pump 40. For example, stream 30 can be pumped to a bromine tower (not shown) for recovery of the Br₂, as will be familiar to those skilled in the art. If desired, either stream 30 or water from stream 30 can be cycled as stream 42 for use as, or added to, stream 18 comprising water used to cool stream 16 in cooler 22. Means for separating water from stream 30 and cooling stream 42 as needed are well known to those skilled in the art.

The stream comprising HBr, e.g., stream 10, can also comprise water or can be anhydrous. When the HBr stream is anhydrous, it may be hot enough such that heating directly with steam is not required. However, in cases where an anhydrous HBr stream needs to be heated, such heating can be accomplished by heating directly with steam or by other suitable means. The stream comprising HBr can also comprise other components, including without limitation, organics and HCl.

The stream comprising oxygen, e.g., stream 12, can comprise other components, including without limitation, nitrogen, argon, and carbon dioxide, and can comprise air.

The stream comprising steam, e.g., stream 14, can come from any suitable source, as will be familiar to those skilled in the art. For example, geothermal steam can be used. Also, water can be heated to form steam by any suitable heating means, as will be familiar to those skilled in the art. As used herein, steam comprises H₂O and can comprise other components.

The stream comprising HBr, e.g., stream 10, can be heated directly with steam while the stream comprising oxygen, e.g., stream 12, is heated separately by any suitable means, as will be familiar to those skilled in the art. Alternatively, when anhydrous HBr is utilized, the stream comprising HBr can be used “as is”, when hot enough, heated directly with steam, or heated by any suitable means. The heated HBr stream and the heated oxygen stream can be input to the reactor separately, or can be combined prior to the reactor and input as a single, combined stream. The stream comprising HBr, the stream comprising oxygen, and the steam can be combined simultaneously. The temperature of the stream or streams just prior to entering the reactor should be higher than about 315° C. The required temperature of the steam depends upon the composition and volume of the HBr and/or oxygen stream to be heated, as will be familiar to one skilled in the art. The steam can be superheated, thus allowing use of a smaller reactor, e.g., reactor 20, and smaller downstream equipment than would otherwise be required.

As used herein, being heated “directly with” steam means that whatever is being heated is contacted by at least a portion of the steam, for example, by injecting steam into the stream comprising HBr, into the stream comprising oxygen, into both such streams, or into a combination of both such streams.

The reactor, e.g., reactor 20, can be constructed from any suitable material. For commercial applicability, reactor 20 should be constructed from corrosion resistant materials, or at least have a corrosion resistant lining. For example, the reactor can be constructed from quartz or acid brick, or can be constructed to have a refractory or zirconia lining. Care should be taken when heating and cooling the reactor not to shock the reactor such that cracks are started.

Cerium-containing compounds useful in processes of this invention can be any suitable cerium-containing compound. Such cerium-containing compounds are used as catalysts. Suitable catalysts are described, e.g., in U.S. Pat. No. 5,366,949 (Schubert), and include cerium bromide, cerium oxide, and the like. A suitable catalyst composition can comprise cerium bromide on zirconia containing supports.

Residence time of the heated HBr and oxygen inside of the reactor can vary depending on factors such as the size of the reactor, whether the contents of the reactor are under pressure, etc., as will be familiar to those skilled in the art.

The product stream exiting the reactor, such as stream 16 in the FIGURE, comprises elemental bromine (Br₂) and water, and can comprise additional components including without limitation HCl, Cl₂ and unreacted HBr. When air is used as the source of oxygen in stream 12, the product stream can comprise nitrogen, argon and other inert substances. When organics are present, e.g., in the stream comprising HBr, the product stream can comprise CO₂.

The product stream is cooled directly with a cooling stream comprising water, e.g., stream 18, in a cooler, e.g., cooler 22. The product stream should be cooled to at least a low enough temperature to produce a liquid product stream. The stream comprising water can also contain other components and can be cooled to the desired temperature for cooling by any suitable means. The cooler can be a suitable direct contact cooler or condenser, such as a packed bed condenser, as will be familiar to those skilled in the art.

As used herein, being cooled “directly with” a cooling stream means that whatever is being cooled is contacted by at least a portion of the cooling stream, for example, by injecting the cooling stream into the product steam.

The cooled product stream comprising H₂O and Br₂, e.g., stream 30, exits the cooler and is typically pumped out of the cooler. Br₂ is recovered from the cooled product stream by known means as discussed herein.

In processes according to this invention, use of heat exchangers is avoided. This is beneficial because such heat exchangers would have to be built from materials able to withstand the corrosive streams being processed; and it is difficult to find materials that can withstand the corrosive nature of the process, in particular materials that would make the process commercially feasible.

It is to be understood that the reactants and components referred to by chemical name or formula anywhere in the specification or claims hereof, whether referred to in the singular or plural, are identified as they exist prior to being combined with or coming into contact with another substance referred to by chemical name or chemical type (e.g., another reactant, a solvent, or etc.). It matters not what chemical changes, transformations and/or reactions, if any, take place in the resulting combination or solution or reaction medium as such changes, transformations and/or reactions are the natural result of bringing the specified reactants and/or components together under the conditions called for pursuant to this disclosure. Thus the reactants and components are identified as ingredients to be brought together in connection with performing a desired chemical reaction or in forming a combination to be used in conducting a desired reaction. Accordingly, even though the claims hereinafter may refer to substances, components and/or ingredients in the present tense (“comprises”, “is”, etc.), the reference is to the substance, component or ingredient as it existed at the time just before it was first contacted, combined, blended or mixed with one or more other substances, components and/or ingredients in accordance with the present disclosure. Whatever transformations, if any, which occur in situ as a reaction is conducted is what the claim is intended to cover. Thus the fact that a substance, component or ingredient may have lost its original identity through a chemical reaction or transformation during the course of contacting, combining, blending or mixing operations, if conducted in accordance with this disclosure and with the application of common sense and the ordinary skill of a chemist, is thus wholly immaterial for an accurate understanding and appreciation of the true meaning and substance of this disclosure and the claims thereof. As will be familiar to those skilled in the art, the terms “combined”, “combining”, and the like as used herein mean that the components that are “combined” or that one is “combining” are put into a container with each other. Likewise a “combination” of components means the components having been put together in a container.

While the present invention has been described in terms of one or more preferred embodiments, it is to be understood that other modifications may be made without departing from the scope of the invention, which is set forth in the claims below.

What is claimed is:

1. A process for producing Br₂ comprising:
a) combining at least HBr and oxygen at at least about 315° C. in the presence of a cerium-containing compound to produce a product stream comprising Br₂ and H₂O; and
b) cooling the product stream directly with a cooling stream comprising water.

2. The process of claim 1 wherein the HBr is anhydrous.

3. The process of claim 1 wherein the product stream is cooled to produce a liquid product stream.

4. A process for producing Br₂ comprising:
a) heating at least HBr and oxygen directly with steam to at least about 315° C.;
b) placing at least the heated HBr and oxygen in the presence of a cerium-containing compound to produce a product stream comprising Br₂ and H₂O; and
c) cooling the product stream directly with a cooling stream comprising water.

5. The process of claim 4 wherein the product stream is cooled to produce a liquid product stream.

6. A process for producing Br₂ comprising:
a) heating HBr directly with steam to a temperature higher than about 315° C.;
b) combining at least oxygen and the heated HBr at at least about 315° C. in the presence of a cerium-containing compound to produce a product stream comprising Br₂ and H₂O; and
c) cooling the product stream directly with a cooling stream comprising water.

7. The process of claim 6 wherein the product stream is cooled to produce a liquid product stream.
